(19) United States
(12) Patent Application Publication
(10) Pub. No.: US 2009/0006792 A1
(43) Pub. Date: Jan. 1, 2009

(54) System and Method to Identify Changed Data Blocks

(76) Inventors: Michael L. Federwisch, Sunnyvale, CA (US); Atul R. Pandit, Sunnyvale, CA (US); Kapil Kumar, Sunnyvale, CA (US)

Correspondence Address: NETWORK APPLIANCE/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/770,589

(22) Filed: Jun. 28, 2007

(51) Int. Cl. G06F 12/16

(52) U.S. Cl. 711/162; 707/E17.01

(57) ABSTRACT

Differences between data objects stored on a mass storage device can be identified quickly and efficiently by comparing block numbers stored in data structures that describe the data objects. Bit-by-bit or byte-by-byte comparisons of the objects' actual data need only be performed if the block numbers are different. Objects that share many data blocks can be compared much faster than by a direct comparison of all the objects' data. The fast comparison techniques can be used to improve storage server mirrors and database storage operations, among other applications.

### FIELD

The invention relates to computer data storage operations. More specifically, the invention relates to rapidly identifying data blocks that have changed between two storage system states.

### BACKGROUND

Contemporary data processing systems often produce or operate on large amounts of data—commonly on the order of gigabytes or terabytes in enterprise-class systems. This data is stored on mass storage devices such as hard disk drives. Individual data objects are usually smaller than an entire disk drive (which may have a capacity up to perhaps several hundred gigabytes) or an array of disk drives operated together (with capacities according to the number of disks in the array and the layout of data on the disks). To allocate and manage the space available on a disk drive or array, a set of data structures called a filesystem is created.

Filesystems can contain many independent data objects (“files”), and frequently permit users to organize files logically into hierarchical groupings. FIG. 2 shows a typical “folders and documents” representation 210 of such a hierarchical arrangement. A “root” directory or folder 220 contains two documents, A 230 and B 240, and a sub-directory C 250, which contains another document, D 260. Filesystems may contain thousands of directories and millions of individual files. As mentioned above, the aggregate size of all the folders, documents and other data objects may be in the gigabyte or terabyte range.

One task that arises often in computer data processing environments is that of comparing two datasets. The data to be compared may be two files, two directories, or two complete directory hierarchies. Most filesystems can support the simplest method of comparing files: a program reads successive bytes from two sources and compares them, printing messages or taking other appropriate action when the bytes are unequal. However, with gigabyte or terabyte datasets, this comparison method can be unacceptably slow. Improved (e.g., faster) methods of detecting differences between data objects are therefore needed.

### SUMMARY

Differences between two stored data objects are identified by performing pairwise comparisons of block numbers from two metadata containers describing the arrays of blocks that make up each object. For each unequal pair of block numbers, the corresponding data blocks are compared bit-by-bit or byte-by-byte. Stored data objects may be block maps identifying allocated and free blocks of a storage volume containing a plurality of point-in-time images of a filesystem.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flow chart illustrating a method according to an embodiment of the invention.

FIG. 2 shows a “folders-and-documents” view of a hierarchical filesystem.

FIG. 3 shows some data structures that may be used to manage a filesystem.

FIG. 4 shows a multi-level tree associating blocks of a data object with an inode that describes the data object.

FIG. 5 shows how a copy-on-write filesystem can share data blocks between related objects.

FIG. 6 shows relationships between filesystem contents and support data structures where an embodiment of the invention is used.

FIG. 7 shows a mirrored storage server environment where an embodiment of the invention can improve performance.

FIG. 8 outlines a method of operating a storage server mirror according to an embodiment of the invention.

FIG. 9 shows that embodiments of the invention can compare arbitrary point-in-time images, not just successive images.

FIG. 10 shows some subsystems and components of a storage server that implements an embodiment of the invention.

### DETAILED DESCRIPTION

In many environments that include large-capacity data storage systems, only a small percentage of the stored data changes from time to time. Backups and similar tasks may be optimized to work only on changed data, so these important tasks can be completed in only a small percentage of the time that a full backup or other data operation would take. However, this assumes that the changed data can be located quickly. If not, then the tasks may take time proportional to the size of the storage system, as the search for changed data squanders the time saved by only processing changed data. Embodiments of the invention examine easy-to-maintain data structures containing metadata, to quickly identify changed data blocks stored on a mass storage device. The procedures described here can pinpoint changes many times faster than a beginning-to-end search of all the data stored on the mass storage device. Furthermore, the data structures that are examined are already maintained in the ordinary course of operations of a filesystem. Thus, the benefits of an embodiment of the invention are available at no additional computational cost in a conventional environment.

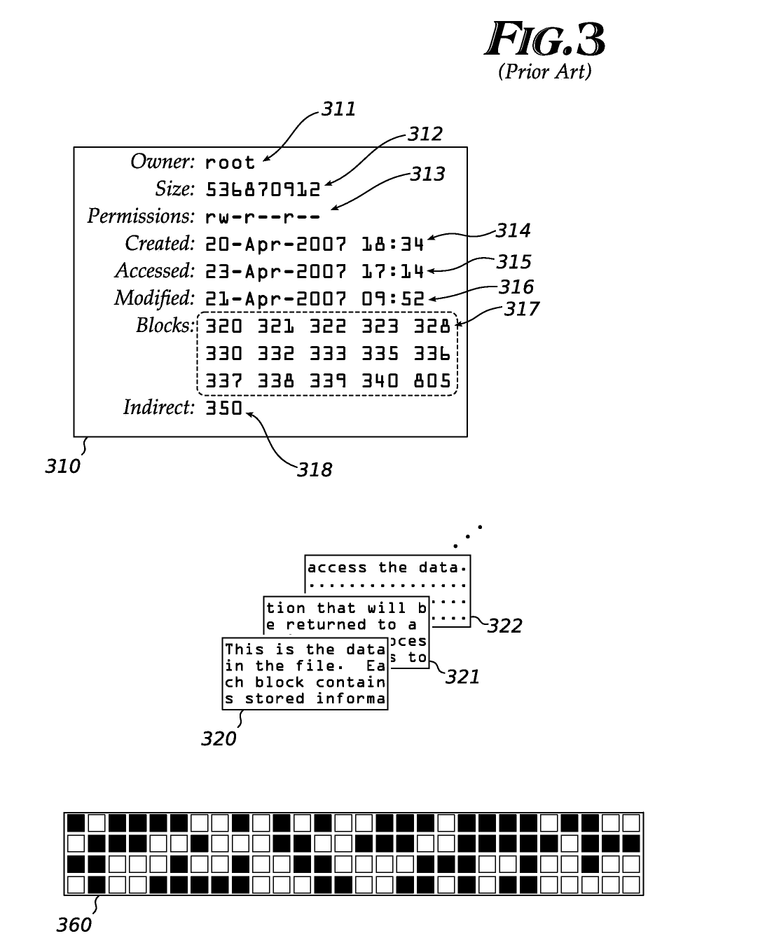

Embodiments of the invention interact closely with filesystem data structures. To provide a framework within which the operations and structures of embodiments can be understood, some typical filesystem data structures and relationships will be described. FIG. 3 shows the principal data structures of a generic filesystem. Element 310 is an inode, which is a data structure that contains information (metadata) about a stored data object such as a file. The information recorded in the inode may include, for example: the owner 311 of the data object, its size 312, permissions 313, creation time 314, last access time 315, last modification time 316, and a list of block indices or identifiers 317 referring to the blocks where the object's data can be found. A data object normally is made of one or more blocks of data. Such data blocks may be 4,096 bytes (“4 KB”) in size, although other data block sizes can be used. (For legibility and ease of representation, 64-byte blocks are shown in FIG. 3. The first few blocks of the data object are shown at 320, 321 and 322.) For the purposes of the present description, an “inode” is specifically defined to be a data structure that is associated with a data object such as a file or directory. An inode contains at least a list of identifiers of data blocks of a mass storage device or subsystem that hold the contents of the data object.

Since an inode has a finite size, a given data object may contain more data blocks than can be listed in the data object's inode. In that case, the inode may contain pointers to other blocks, known as “indirect blocks,” that contain pointers to the actual data blocks. For even larger data objects, double or even triple-indirect blocks may be used, each to contain indices or pointers to lower-level indirect blocks, which ultimately contain pointers to actual data blocks. Thus, the inode may form the “root” of a multi-level “tree” of direct and indirect blocks, representing the data object, the number of levels of which depends on the size of the data object. In the following discussion, it will sometimes be important that block numbers are stored in a multi-level tree. At other times, it is only important that the complete list of identifiers of data blocks that make up a data object can be accessed starting with information in the inode.

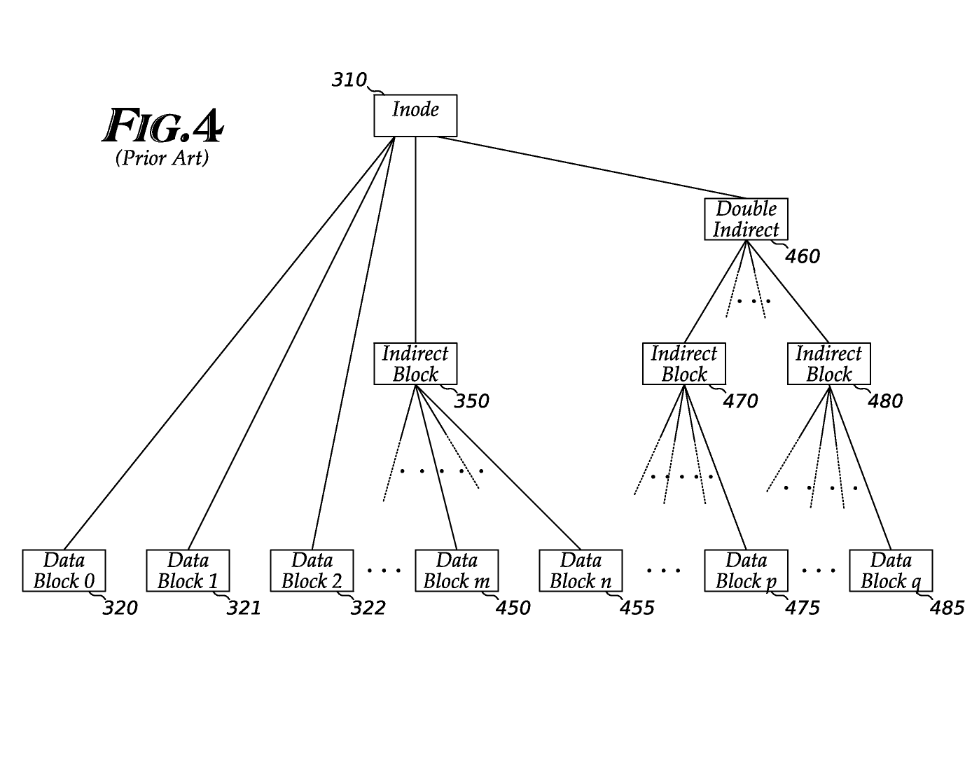

FIG. 4 shows an example of a multi-level tree of direct and indirect blocks. Inode 310 contains pointers to several data blocks 320, 321, 322, which contain some of the data of the object corresponding to inode 310. Inode 310 also contains a pointer to indirect block 350, which contains pointers to other blocks including data block m 450 and data block n 455. Finally, FIG. 4 shows that inode 310 contains a pointer to double indirect block 460, which contains pointers to indirect blocks including 470 and 480. These indirect blocks contain pointers to additional blocks that contain portions of the data object (data block p 475 and data block q 485). The tree of direct and indirect blocks permits extremely large data objects to be stored on a filesystem.

Returning briefly to FIG. 3, a second data structure that is commonly found in a filesystem is block map 360. The block map is a bitmap (or array of bytes, in some implementations), each bit of which indicates whether a corresponding block of the mass storage device is free or in use. (In FIG. 3, and in other Figures, block maps will be shown as arrays of white or black boxes; a white box indicates a free block, and a black box indicates an in-use block.) Many different filesystem implementations exist, but most contain data structures similar to the inode 310 and block map 360 shown in FIG. 3.

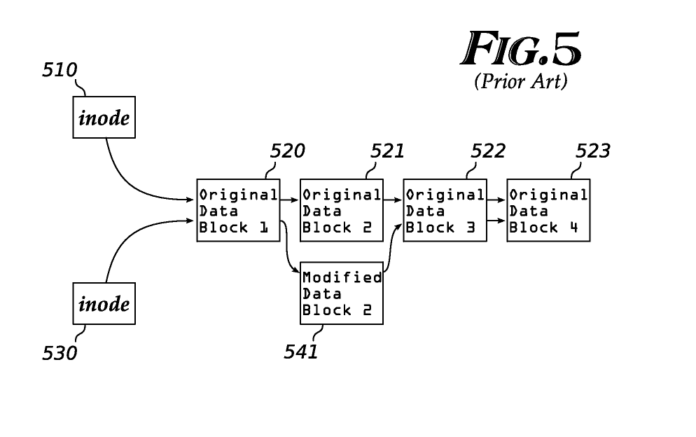

FIG. 5 shows a filesystem operation style that can save storage space and provide useful functionality. An inode 510 identifies blocks of a data file 520, 521, 522 and 523, as described with reference to FIGS. 3 and 4. If a portion of the data file is overwritten, the new data could simply be stored in one of the existing blocks of the file, overwriting the data currently stored there (not shown). However, if a second inode 530 is prepared that refers to most of the same data blocks (520, 522 and 523), with a new data block 541 replacing 521, then the new data can be stored in the new data block 541, while the original file remains unchanged. The pre-change version of the file is visible through inode 510, while the post-change version of the file is accessible through inode 530. Data blocks 520, 522 and 523 are shared between the files. This operational style is sometimes called “copy-on-write” (“CoW”) because data blocks are shared until a write occurs, and then a copy of the block to be written is made (only the copy is modified). One commercially-available filesystem that implements copy-on-write is the Write Anywhere File Layout (“WAFL®”) filesystem, which is part of the Data ONTAP® storage operating system in storage servers available from Network Appliance Inc. of Sunnyvale, Calif. Filesystems from other vendors may offer similar functionality. At a modest cost in data storage space, an arbitrary number of historical versions (“point-in-time images”) of files can be kept available for future reference. Furthermore, since in a hierarchical file system, directories are often implemented as specially-formatted files, this technique can be used to preserve point-in-time images of directories, too, or of entire filesystems. The cost of maintaining each previous version of a filesystem's contents (i.e., the amount of storage required to maintain previous versions) is roughly proportional to the amount of data changed between the version and its successor.

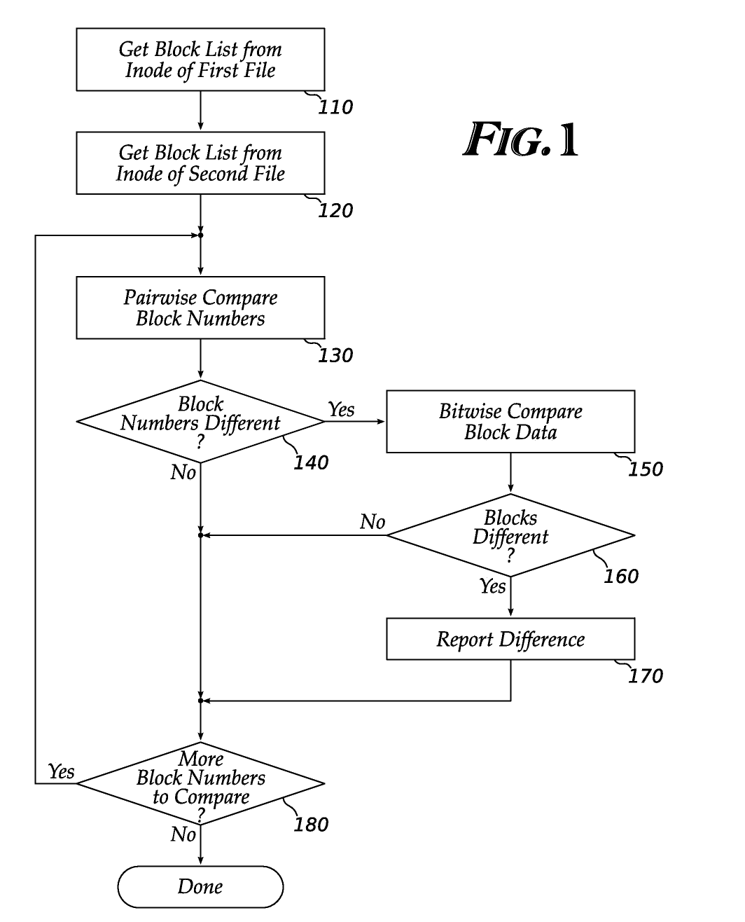

Given this sort of filesystem structure, an embodiment of the invention can compare two data objects much faster than by reading each object byte-by-byte and comparing the bytes. The method is outlined in the flow chart of FIG. 1: a block list of the first object (e.g., a file, directory or other data object) is obtained from a first inode (110), and a block list of the second object (another file, directory or other data object) is obtained from a second inode (120). Both block lists include the block indices in the inodes themselves, as well as identifiers of any singly- or multiply-indirect blocks. Next, corresponding pairs of block numbers in each list are compared (130). If the block numbers are different (140), then the data blocks must be compared bit-by-bit or byte-by-byte (150). If the data blocks are different (160), then a message may be printed (170) or other action taken in response to the difference. If block numbers of indirect blocks are different, then the algorithm operates recursively to compare the block numbers at the next-lower level of indirection. If, during this recursive processing, direct block numbers are found to differ, then those data blocks must also be compared bit-by-bit or byte-by-byte, and any differences noted.

If, however, the block numbers (or indirect block numbers) are the same (140), then the time-consuming bit-by-bit comparison can be skipped. The two objects share the data block (or the sub-tree of indirect blocks), so there cannot be any difference between those corresponding portions of the objects.

If there are more block numbers in the lists to compare (180), the procedure continues with the next pair of numbers.

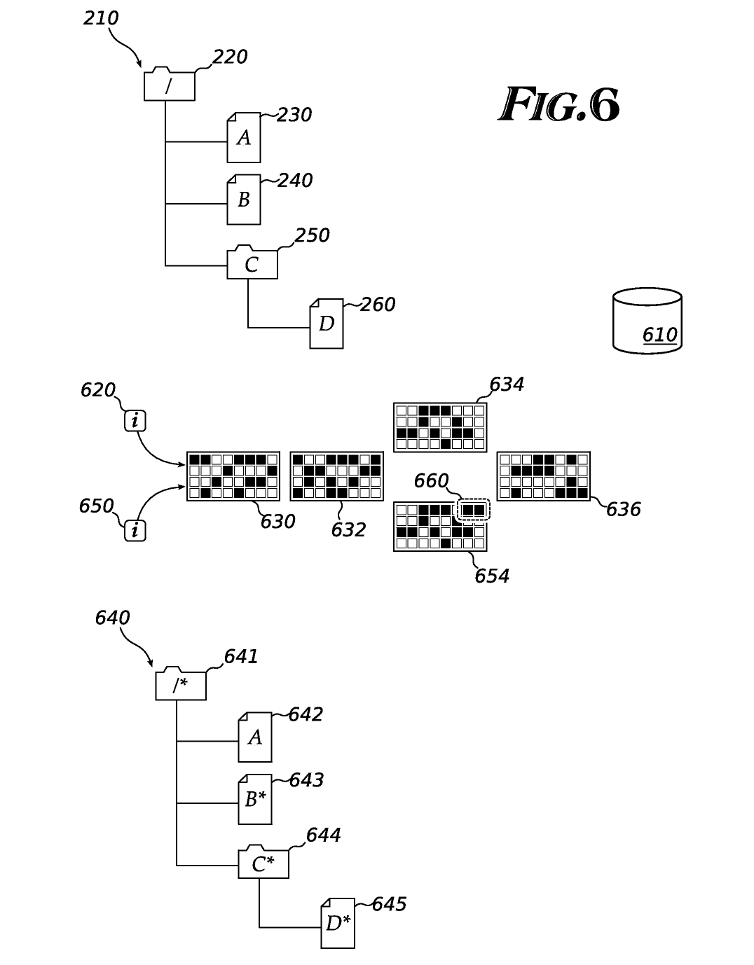

The method outlined in FIG. 1 is particularly effective for comparing large files that share many of their data blocks. FIG. 6 shows an application where this capability provides great benefits.

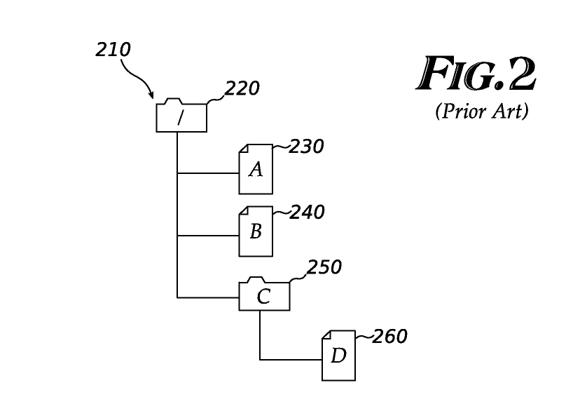

In a storage server containing, for example, the hierarchical filesystem 210 shown in FIG. 2 (reproduced here as root directory 220, files 230, 240 and 260, and subdirectory 250), all of the file and filesystem data (e.g., inodes, data blocks, etc.) may be stored on mass storage device 610. Some of the data blocks will contain the filesystem's block map (in this Figure, these blocks are identified as 630, 632, 634 and 636). An inode 620 lists the data blocks that hold the block map. (Inode 620 may be listed as a special or administrative file in root directory 220, or may be stored elsewhere by the server's filesystem logic.)

If some data objects (e.g., files and directories) in the filesystem are modified, the filesystem may come to resemble the hierarchy shown at 640: root directory 641, files B 643 and D 645, and subdirectory C 644 have all changed (changes indicated by asterisks appended to these objects' names). File A 642 is unchanged, so all of its blocks will be shared with file A 230. The changes will result in the allocation of new data blocks to hold the copied-on-write data, so the block map will also be modified. Since in this embodiment, the block map is maintained very much like any other data file, a new inode 650 will have been allocated to refer to the modified block map, and a new data block 654 will contain the modifications that distinguish the current block map from the block map that corresponds to the pre-change hierarchy 210. (Changed bits of the block map are indicated at element 660.)

Suppose it is desired to locate all the data blocks that were changed between filesystem state 210 and filesystem state 640. A slow, recursive, byte-by-byte comparison of every data object in the two filesystems might be made, or, according to one embodiment of the invention, the block numbers in the inodes describing each data object could be compared. (These inodes are not shown in this Figure.) However, another embodiment can accomplish the task even more quickly. Since the block map of a file system indicates which blocks are in use and which blocks are free, and since a copy-on-write filesystem allocates a new block every time data is modified (or when new data is stored), “before” and “after” block maps can be compared to identify blocks that used to be free, but are now in use. These blocks will contain the complete set of changes between the two filesystem states. Changes between user data (e.g., ordinary files) will be located, as will changes between any other data objects stored in the volume. Thus, no special processing is needed to find changes between system data structures that are stored in the filesystem but maintained internally for administrative purposes (i.e., non-user data). (Traditional block maps do not contain information to associate a block with the data object(s) that incorporate the block, but this information is not necessary to perform several useful functions, discussed below.)

Furthermore, a bit-by-bit comparison between the “before” and “after” block maps is not necessary—as depicted in FIG. 6, each block map is stored in a series of blocks (some of which may be shared), and the series of block indices is stored in the inode associated with the block map, just as block indices are stored in an inode associated with an ordinary user file. Therefore, an embodiment of the invention can compare two block maps quickly by comparing the block indices in inodes associated with the block maps. In FIG. 6, these are inodes 620 and 650. As the following numeric analysis shows, comparisons can be accelerated by several orders of magnitude.

The filesystems shown in the simple example of FIG. 6 have only a few data objects, and the block maps have only 4 blocks' worth of bitmap data. An example helps illustrate how powerful the inode block-number comparison of an embodiment of the invention is. Consider a storage system of moderate size (by today's standards): 16 terabytes (“TB”). Such systems are not unusual, and advances in data recording technology make it likely that systems of this size will become more common (and larger systems will be deployed as well). A 16TB volume, administered as 4,096-byte (“4 KB”) data blocks, contains 4,294,967,296 such blocks. A block map that dedicates a single bit of each eight-bit byte to indicate the state (free or allocated) of each block in the volume would itself occupy 536,870,912 bytes (512 MB), or 131,072 data blocks. Comparing two such block maps, or even reading one of them, may consume a significant amount of a system's input/output (“I/O”) bandwidth.

On the other hand, an inode may store (or reference through its indirect blocks) the indices of the block map data blocks in only 256 data blocks (assuming, generously, that each index is stored as an eight-byte number). Therefore, an embodiment of the invention can compare two states of a 16 TB volume and identify every block that is different between them by reading at most two sets of 256 4 KB data blocks, and performing pairwise comparisons of the eight-byte block index numbers contained therein, and then reading and comparing any pairs of blocks whose indices do not match. In the limiting case (the filesystem states are identical), an embodiment turns the practically impossible task of comparing two sets of ˜1.76×10¹³ data bytes into the almost-trivial task of comparing two sets of 131,072 long integers. The difficulty of the task of comparing two states of a volume essentially becomes proportional to the number of changes between the two states of a volume, and independent of the size of the volume. (The foregoing analysis is pessimistic because it ignores indirect blocks for simplicity. If indirect blocks are used, the comparison can be made even more rapidly.)

Operations according to an embodiment of the invention multiply the power of a comparison operation in three ways. First, each bit of the block map represents a data block. Therefore, comparing two different block map blocks can detect differences between 32,768 data blocks (assuming 4 KB data blocks and eight-bit bytes). (In general, the “amplification” of a comparison at this level is proportional to the size of a data block times the number of blocks represented by a byte of the data block. Thus, for example, if the block map uses one byte per block, rather than one bit per block, the comparison between two block map blocks detects differences between n blocks, where n is the number of bytes in a data block.)

Second, each data block identifier or index in the block map file's inode identifies a block containing 32,768 bits. A data block identifier may be, for example, 64 bits (eight bytes), so comparing two data block identifiers achieves a further “amplification” of 512 times. Third, although indirect blocks were not considered above, an indirect block that is shared between two filesystem states provides another factor of 512, because a single indirect block identifier corresponds to 512 direct block identifiers. Additional levels of indirection provide further multiplication of comparison effectiveness. It takes much less work to compare two sets of data block indices from two inodes than to compare all the data blocks that the indices represent.

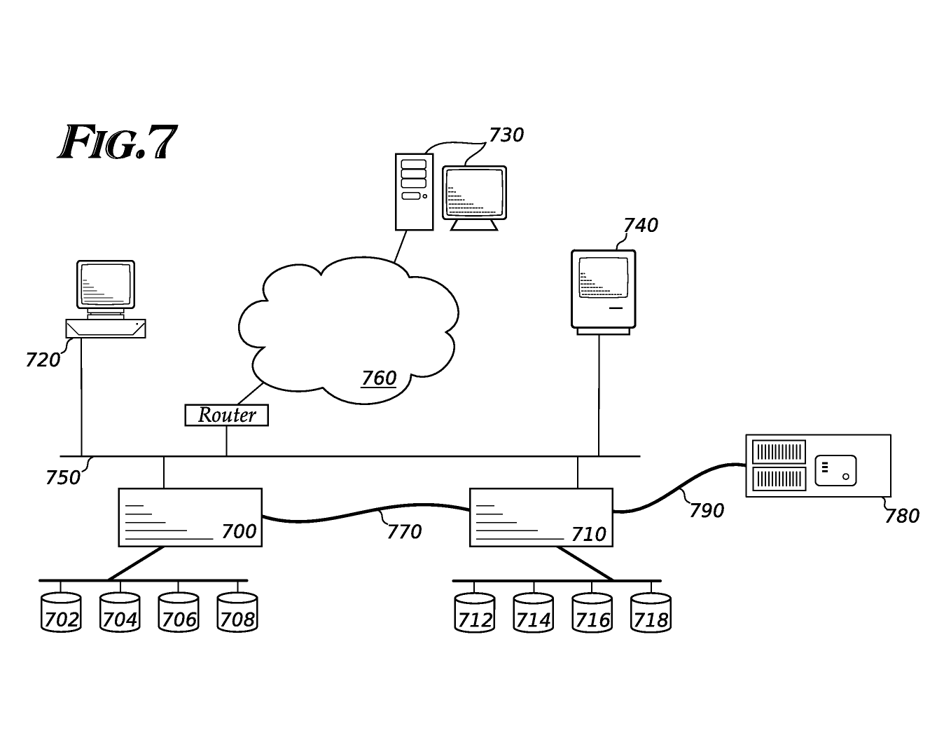

FIG. 7 shows an environment where an embodiment of the invention operates. Systems 700 and 710 are network-accessible storage servers that provide data storage services to clients such as 720, 730 and 740. These clients may connect directly to a local area network (“LAN”) 750, or through a distributed data network 760 such as the Internet. Data from the clients is stored on mass storage devices 702-708 and/or 712-718, which are connected to servers 700 and 710, respectively. The mass storage devices (e.g., hard disks) attached to either server may be operated together as a Redundant Array of Independent Disks (“RAID array”) by hardware, software, or combination of hardware and software (not shown) present in a server. A dedicated communication channel 770 between server 710 and server 720 may improve the performance of some inter-server cooperative functions described shortly. Server 710 also provides data storage services to a client 780, which is connected to the server over an interface 790 that typically connects a computer system to a mass storage device. Examples of such interfaces include the Small Computer Systems Interface (“SCSI”) and Fiber Channel (“FC”). Server 710 may emulate an ordinary mass storage device such as a hard disk drive, but store client 780's data in a file stored in a filesystem maintained on mass storage devices 712-718.

Servers 700 and 710 may both implement copy-on-write filesystems as described above to manage the space available on their mass storage devices and allocate it appropriately to fulfill clients' storage requests. Commercially-available devices that fit in the environment shown here include the Fabric-Attached Storage (“FAS”) family of storage servers produced by Network Appliance, Inc. of Sunnyvale, Calif. The Data ONTAP software incorporated in FAS storage servers includes logic to maintain WAFL filesystems, and can be extended with an embodiment of the invention to identify changed data blocks between two point-in-time images of a filesystem.

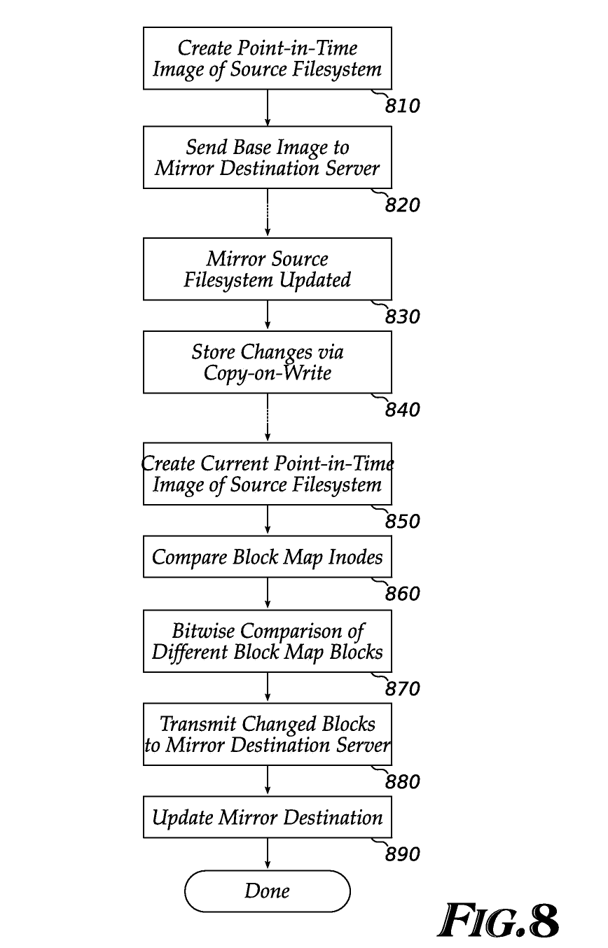

Cooperating storage servers such as systems 700 and 710 in FIG. 7 may be configured to maintain duplicate copies of each others' data for redundancy and fault tolerance reasons. Such duplicate copies are sometimes called “mirrors.” Mirrored servers may be located in physically separate data centers to decrease the risk of data loss due to a catastrophic failure. FIG. 8 outlines a process by which the servers can cooperate to maintain a mirror of a filesystem. The process is facilitated by an embodiment of the invention.

A point-in-time image of the filesystem to be mirrored is created (810). This filesystem is called the “mirror source filesystem,” and the initial point-in-time image is the “base image.” A point-in-time image can be created by noting the inode referring to the root directory of the filesystem; all other files and directories in the point-in-time image can be reached by descending the filesystem hierarchy. The base image is transmitted to the second storage server and stored there (820). The second storage server is the “mirror destination server,” and the data stored there includes the “mirror destination filesystem.” Operations 810 and 820 set up the initial mirror data set. The initial data transfer may be quite time-consuming if the initial data set is large; a dedicated communication channel between the servers (such as that shown at 770 in FIG. 7) may be useful to accelerate the initial transfer.

As time progresses, modifications to the mirror source filesystem are made by clients of the mirror source server (830). These changes are stored via copy-on-write procedures described earlier (840). Periodically, the mirror destination filesystem is updated to accurately reflect the current contents of the mirror source filesystem. A current point-in-time image of the mirror source filesystem is created (850) (again, by noting the inode that presently refers to the root directory of the filesystem), and the inodes of the current point-in-time image's block map and the previous point-in-time image's block map are compared (860) as described with reference to FIG. 1. Differently-numbered block map blocks are compared bit-by-bit (870) for every point-in-time image between previous and current including current image to identify blocks that are different between the point-in-time images. Finally, the contents of the identified data blocks are transmitted to the mirror destination server (880) and used to update the mirror destination filesystem (890). Since the mirror destination filesystem is an exact copy of the mirror source filesystem, it is not necessary to look through the filesystem to determine which data object (e.g., file or directory) contains which of the identified blocks. The mirror source filesystem is maintained coherently and correctly on the mirror source server (i.e., filesystem logic ensures that there is no question which blocks contain data for which versions of a file, shared blocks are protected against modification by copy-on-write procedures, and so on); so the data is correctly formatted for filesystem logic at the mirror destination server also.

The foregoing method of maintaining a mirror destination volume is able to quickly identify changed blocks, and only those changed blocks must be sent to the mirror destination to keep the filesystems synchronized. Therefore, mirror-related communications between the mirror source and destination servers are limited to change data. This reduces the impact of mirror operations on the systems' resources, preserving more of these resources for use by clients.

It will be appreciated that the foregoing method can also be used to maintain a mirror of a storage area network (“SAN”) volume. Blocks in a SAN volume are not managed by a filesystem or other data structure maintained by the storage server, although a SAN client may construct and maintain its own filesystem within the blocks. The data blocks' contents may be stored in a contaner file that is part of a filesystem managed by the SAN server. A point-in-time image of the container file filesystem permits changes between two states of the container file to be identified. Alternatively, a block map for the SAN volume can track blocks as they come into use by the SAN client, and the inode block comparison method of an embodiment can be used to determine which SAN blocks have been changed.

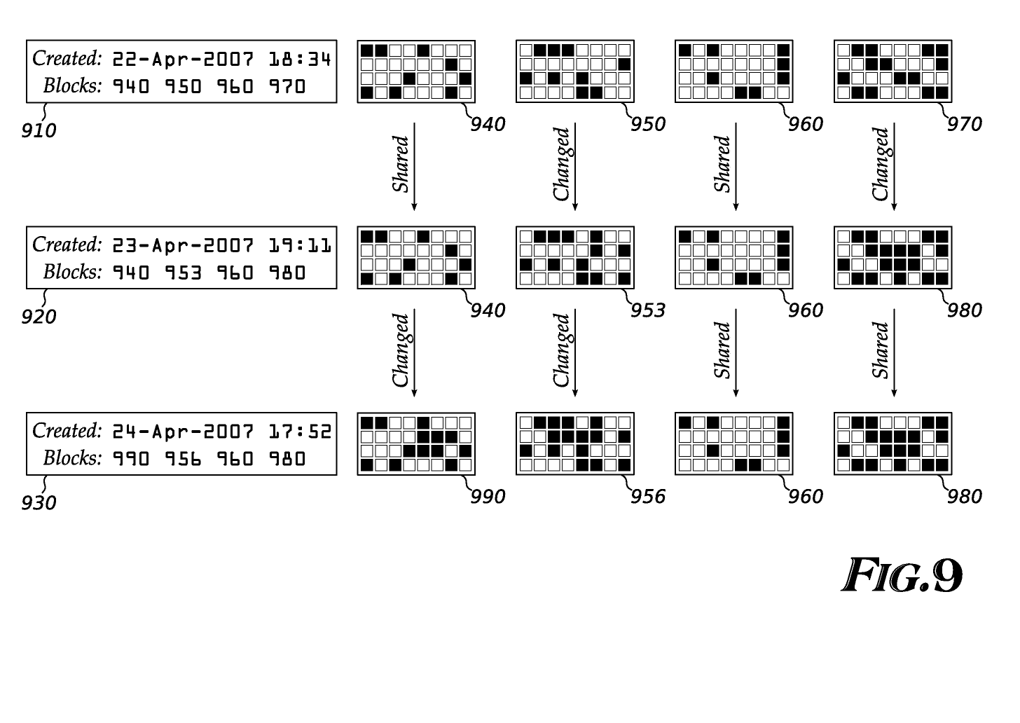

Note that block map inode comparisons according to an embodiment of the invention can be used to identify changed data blocks between any two point-in-time images, not just two successive images. FIG. 9 shows three inodes 910, 920 and 930, which describe the block map files for three successive point-in-time images of a filesystem. The first point-in-time image block map includes blocks 940, 950, 960 and 970. The second point-in-time image block map shares two blocks 940 and 960 with the first (or base) image, but includes changed blocks 953 and 980 for the other two blocks. A comparison between the block numbers in inodes 910 and 920 according to an embodiment of the invention would lead to bit-by-bit comparisons of blocks 950 and 953; and blocks 970 and 980. Later still, another point-in-time image is created, and its block map file is associated with inode 930. The blocks associated with inode 930 are 990, 956, 960 and 980. A comparison between the block numbers in inodes 910 and 930 (skipping over the block map file associated with inode 920) would lead to bit-by-bit comparisons of blocks 940 and 990; blocks 950, 953 and 956; and blocks 970 and 980. Block map comparisons via inode differencing can be used to establish a mirror baseline, by comparing a blank (initial) block map to the block map describing the filesystem state when the mirror is to be established.

Embodiments of the invention can also be applied outside the field of data storage servers such as Fabric Attached Storage (“FAS”) and Storage Area Network (“SAN”) servers. Database systems, such as relational database systems, often incorporate specialized storage management logic to take advantage of optimization opportunities not available to a general-purpose filesystem server. This storage management logic may implement semantics similar to copy-on-write to reduce the system's demand for data storage space. Although a database's storage management system may not implement a fully-featured filesystem, block maps and inode-like data structures can be incorporated, and an embodiment of the invention can be used to identify changed data blocks between two states of the database's storage. Changed-block identification can reduce communication demands for maintaining a replica of the database, or permit smaller, faster backup procedures where only blocks changed since a previous backup are written to tape or other backup media.

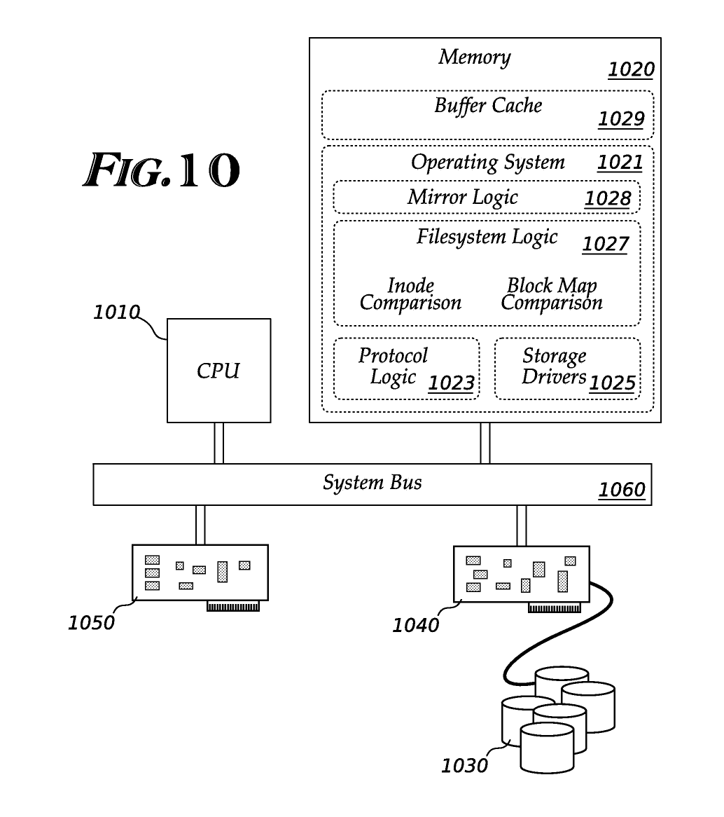

FIG. 10 shows some components and subsystems of a storage server that incorporates an embodiment of the invention. A programmable processor (central processing unit or “CPU”) 1010 executes instructions stored in memory 1020 to perform methods according to embodiments of the invention. Instructions in memory 1020 may be divided into various logical modules. For example, operating system instructions 1021 manage the resources available on the system and coordinate other software processes. Operating system 1021 may include a number of subsystems: protocol logic 1023 for interacting with clients according to SAN or NAS protocols such as the Network File System (“NFS”) protocol, the Common Internet File System (“CIFS”) protocol, or iSCSI; storage drivers 1025 to read and write data on mass storage devices 1030 by controlling device interface 1040; and filesystem logic 1027, including inode comparison and block map comparison functions according to embodiments of the invention. Mirror logic 1028 may implement methods for interacting with a second storage server (not shown) via a network or other data connection, to maintain a mirror image of a filesystem stored on mass storage devices 1030, the mirror image to be stored on mass storage devices at the second storage server. Some portions of memory 1020 may be devoted to caching data read from (or to be written to) mass storage devices 1030. Logic to operate a plurality of mass storage devices as a Redundant Array of Independent Disks (“RAID array”) may reside in storage drivers 1025 or device interface 1040, or may be divided among several software, firmware and hardware subsystems. A communication interface 1050 permits the system to communicate with its clients over a network (not shown).

An embodiment of the invention may be a machine-readable medium having stored thereon instructions which cause a programmable processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROM), Read-Only Memory (ROM), Random Access Memory (RAM), and Erasable Programmable Read-Only Memory (EPROM).

The applications of the present invention have been described largely by reference to specific examples and in terms of particular allocations of functionality to certain hardware and/or software components. However, those of skill in the art will recognize that changed data blocks in an mass storage system can also be identified efficiently by software and hardware that distribute the functions of embodiments of this invention differently than herein described. Such variations and implementations are understood to be captured according to the following claims.

We claim:

1. A method comprising:
performing pairwise comparisons of block identifiers from a first metadata container with corresponding block identifiers from a second metadata container;
for each unequal pair of block identifiers detected during said comparisons, performing a comparison of a first data block associated with a first block identifier of the pair of block identifiers and a second data block associated with a second block identifier of the pair of block identifiers; and
identifying a set of blocks associated with each bit of the first data block that is different from a corresponding bit of the second data block.

2. The method of claim 1, wherein
said first metadata container describes a first block map file of a filesystem in a first state; and
said second metadata container describes a second block map file of said filesystem in a second state.

3. The method of claim 2 wherein said filesystem is a copy-on-write filesystem.

4. The method of claim 1, further comprising:
transmitting said set of blocks to a cooperating mirror destination server to update a mirror destination filesystem.

5. The method of claim 1, further comprising:
storing said set of blocks on a backup medium.

6. The method of claim 1, further comprising:
maintaining a series of point-in-time images of a filesystem, said series including at least three point-in-time images; wherein
said first metadata container corresponds to a block map of a first of the point-in-time images, and said second metadata container corresponds to a block map of a last of the point-in-time images.

7. A storage server comprising:
filesystem logic to maintain a copy-on-write (“CoW”) filesystem;
a mass storage system to store data in a plurality of data blocks, each data block identified by an index;
a first block map to identify data blocks of the plurality of data blocks that are used by a first point-in-time image of the CoW filesystem;
a second block map to identify data blocks of the plurality of data blocks that are used by a second point-in-time image of the CoW filesystem;
a first data structure storing a first list of a plurality of blocks of the first block map;
a second data structure storing a second list of a plurality of blocks of the second block map; and
comparison logic to compare the first list with the second list to identify data blocks that are different between the first point-in-time image and the second point-in-time image.

8. The storage server of claim 7 wherein the mass storage system is a Redundant Array of Independent Disks (“RAID Array”).

9. The storage server of claim 7, further comprising:
mirror logic to transmit data blocks identified by the comparison logic to a mirror destination server.

10. The storage server of claim 7, further comprising:
a dedicated communication channel to carry data blocks identified by the comparison logic to a mirror destination server.

11. A method comprising:
storing a first block map file in a first plurality of data blocks of a mass storage system;
storing a second block map file in a second plurality of data blocks of the mass storage system, at least one data block to be a member of both the first plurality and the second plurality; and
comparing a first list of block identifiers of the first plurality of data blocks with a second list of block identifiers of the second plurality of data blocks to identify blocks that are in only the first plurality or only the second plurality.

12. The method of claim 11 wherein the first list of block identifiers is stored in a first inode, and the second list of block identifiers is stored in a second inode.

13. The method of claim 11, further comprising:
comparing a first data block that is only part of the first plurality of data blocks with a second data block that is only part of the second plurality of data blocks; and
identifying a set of changed data blocks based on differences between the first data block and the second data block.

14. The method of claim 13, further comprising:
transmitting the set of changed data blocks to a mirror destination server to update a mirror image of a filesystem.

15. The method of claim 13, further comprising:
storing the set of changed data blocks on a backup medium.

16. A system comprising:
a first storage server to maintain a mirror source filesystem;
a second storage server to maintain a mirror destination filesystem as a copy of the mirror source filesystem; and
inode comparison logic to identify a set of changed blocks of the mirror source filesystem by comparing an inode of a first block map file to an inode of a second block map file.

17. The system of claim 16, further comprising:
mirror maintenance logic coupled with the second storage server to receive the set of changed blocks of the mirror source filesystem and update the mirror destination filesystem.

18. The system of claim 16 wherein the first block map is a block map of a first point-in-time image of the mirror source filesystem, and the second block map is a block map of a second point-in-time image of the mirror source file system.

19. A machine-readable medium containing data and instructions to cause a programmable processor to perform operations comprising:
maintaining a first multi-block map to identify a first subset of blocks of a mass storage system;
maintaining a second multi-block map to identify a second subset of blocks of the mass storage system, at least one block of the second multi-block map to be shared with the first multi-block map;
comparing block numbers of the first multi-block map with block numbers of the second multi-block map; and
comparing data blocks corresponding to block numbers that are in only one of the first multi-block map and the second multi-block map to identify a changed subset of blocks of the mass storage system.

20. The machine-readable medium of claim 19, containing additional data and instructions to cause the programmable processor to perform operations comprising:
managing a copy-on-write filesystem with multiple point-in-time image capability, wherein
the block numbers of the first multi-block map are stored in a first inode, and
the block numbers of the second multi-block map are stored in a second inode.

21. The machine-readable medium of claim 20, wherein the first inode is associated with a root directory of a first point-in-time image and the second inode is associated with a root inode of a second point-in-time image.
